(19) United States
(12) Patent Application Publication
(10) Pub. No.: US 2003/0226340 A1
(43) Pub. Date: Dec. 11, 2003

(54) A DEVICE FOR CROP PROCESSING

(75) Inventors: Cornelis Christianus Franciscus HAVERMANS, Zevenbergschenhoek (NL); Theo Jan MIEDEMA, De Lier (NL); Karel van den BERG, Bleskensgraaf (NL); Alexander van der LELY, Rotterdam (NL)

Correspondence Address: HOWREY SIMON ARNOLD & WHITE, CITYPOINT, ONE ROPEMAKER STREET, LONDON, EC2Y 9HS, GB

(73) Assignee: LELY ENTERPRISES AG, Zug (CH)

(21) Appl. No.: 10/250,105

(22) Filed: Jun. 4, 2003

(30) Foreign Application Priority Data
Jun. 6, 2002 (NL) 1020790

(51) Int. Cl. A01D 75/28

(52) U.S. Cl. 56/10.2 R

(57) ABSTRACT

A device for crop processing. The device is autonomously movable, and is provided with a mowing unit for mowing the crop, with a rake unit for raking mown crop, and with a tedder unit for tedding mown crop. The device is further provided with a position-determining system for determining the position of the device, with a boundary-detecting system for detecting a boundary of mown crop, and with a control device for controlling the device with the aid of data from the position-determining system and/or the boundary-detecting system.

### CROSS REFERENCE TO RELATED APPLICATIONS

This application claims priority from Dutch patent application no. 1020790 filed Jun. 6, 2002, the contents of which are hereby incorporated by reference in their entirety.

### BACKGROUND OF INVENTION

1. Field of Invention

The invention relates to the field of agriculture and more particularly to a device for crop processing.

2. Description of the Related Art

A disadvantage of known devices for crop processing is that, for providing sufficient capacity, they need to have a relatively large working width with all the disadvantages attached thereto, for example in relation to road transport, energy consumption and cost price.

### SUMMARY OF INVENTION

According to the present invention there is provided a device for crop processing in which the above-mentioned disadvantages are minimised or completely eliminated.

For this purpose the invention provides an autonomously movable device for crop processing, which device is provided with a mowing unit for mowing the crop, a rake unit for raking mown crop, and with a tedder unit for tedding mown crop. By using an autonomously movable device, i.e. a device that does not require a driver for being moved, the device can be active substantially 24 hours a day. The desired capacity can then be taken from the working duration instead of the working width. Therefore, the device according to the invention can be designed as a relatively small device.

The tedder unit is preferably designed in such a way that it enables the performance of several functions. The tedder unit may in particular be provided with a crushing device for crushing the crop. Additionally or alternatively, the tedder unit may be provided with a picking-up device for picking up the crop.

Depending on the wishes of the user it is advantageous that the autonomous device according to the invention can perform each processing operation separately or can perform several processing operations simultaneously. In an embodiment of device according to the invention this is possible if the device is provided with a switching device for switching on or switching off at least one of the units from the group consisting of the mowing unit, the rake unit and the tedder unit. It is then advantageous if the switching device can additionally or alternatively switch on or switch off at least one of the devices from the group consisting of crushing equipment and picking-up equipment.

Although it is possible to use various known mowing units in the autonomous device according to the invention, it has unexpected advantages to use a cage-mower as mowing unit. By means of such a cage-mower it is possible for example to convey the mown crop in a simple manner to a receptacle or a drag bag.

In an embodiment of a device according to the invention, the tedder unit may be a drum-tedder with a comb. Due to this, the drum-tedder can pick up the crop which is then guided through the comb, so that a frictional crushing effect is created. By disposing the comb hingeably in the drum-tedder, the comb may be switched off so that a normal drum-tedder is created.

In further embodiments of a device according to the invention, the device may be provided with a position-determining system for determining the position of the device, with a boundary-detecting system for detecting a boundary of mown crop, and/or with a control device for controlling the device with the aid of data from the position-determining system and/or the boundary-detecting system. When the crop needs to be tedded for example, it may be difficult to determine only on the basis of the position of the device where tedding has already taken place. By leaving uncovered a boundary that can be detected by the boundary-detecting system, for example, along the edge of the working width, the surface to be processed can be processed accurately.

In order to prevent animals or human beings from being injured by the units or equipment of the device, the device may be provided with protecting means for protecting the device. Such protecting means may be protecting elements and devices as described in the below mentioned co-pending applications.

### BRIEF DESCRIPTION OF DRAWINGS

Embodiments of the invention will now be explained in further detail by way of example only with reference to the accompanying figures, in which:

FIG. 1 shows schematically a perspective view of a device for processing crop according to the invention;

FIG. 2 shows schematically in plan view the crop-processing parts of a device for processing crop according to the invention; and

FIG. 3 shows schematically in side view the crop-processing parts of a device for processing crop according to the invention.

### DETAILED DESCRIPTION

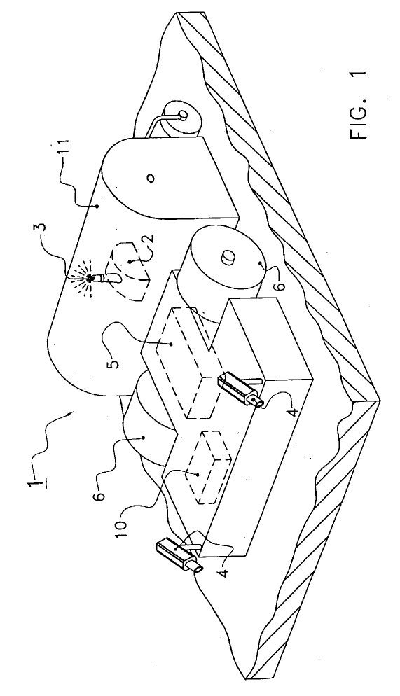

FIG. 1 shows schematically a perspective view of a device 1 for processing crop according to the invention. Various aspects of autonomous crop processing machines are disclosed in co-pending U.S. patent application Ser. No. ______ entitled “An Agricultural Machine for Performing an Agricultural Operation” Ser. No. ______ entitled “An Agricultural Machine for Performing Crop Processing” Ser. No. ______ entitled “An Autonomous Agricultural Machine for Performing an Agricultural Operation, in Particular Crop Processing” Ser. No. ______ entitled “An Assembly for Performing Crop Harvesting” Ser. No. ______ entitled “A System for and a Method of Performing a First and a Second Agricultural Operation on an Agricultural Parcel” Ser. No. ______ entitled “An Assembly for Performing an Agricultural Operation, in Particular Crop Processing” Ser. No. ______ entitled “An Agricultural Machine for Performing an Agricultural Operation, in Particular Crop Processing” and Ser. No. ______ entitled “An Assembly and an Autonomous Agricultural Machine for Performing an Agricultural Operation, in Particular Crop Processing”, all of which claim priority in the Netherlands on Jun. 6, 2002. The contents of these applications are hereby incorporated by reference in their entirety.

The device 1 can be moved autonomously by determining, with the aid of a position-determining system 2, provided with an aerial 3 if desired, the position of the device 1 in the field to be processed. Such position-determining systems are known per se, for example GPS, DGPS, Galileo, or position determination by means of beacons and the like. The device 1 further comprises a boundary-detecting system 4, for example one or more cameras or another boundary-detecting system known per se, for detecting a boundary of already mown crop, for example already mown crop that has been tedded or deposited in a swath. In the case that the crop-processing does not automatically produce a boundary, the device can be controlled in such a way that a detectable boundary is produced. With the aid of data from the position-determining system 2, 3 and/or the boundary-detecting system 4, a control device 5 for controlling the device 1, in particular the driving motor and the wheels 6 thereof, is controlled so that the device 1 follows a track in the field to be processed.

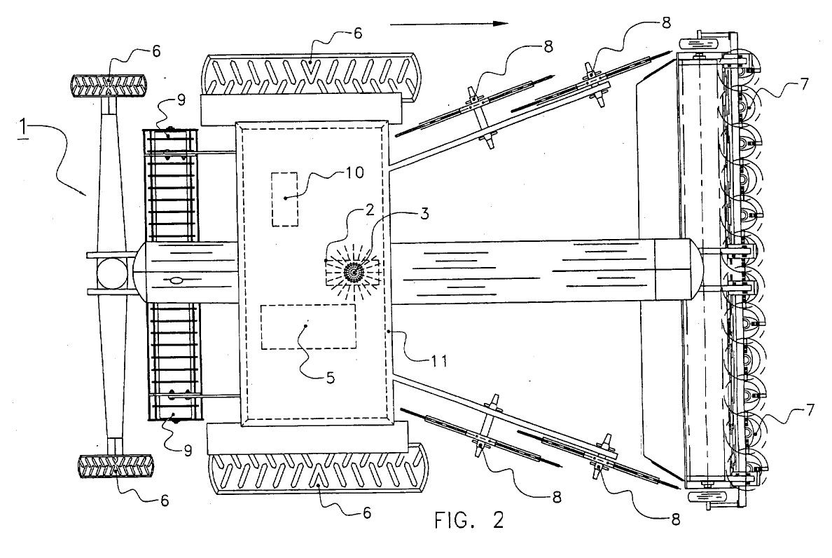

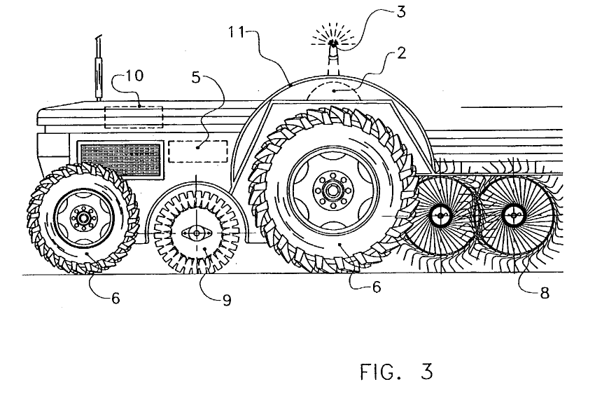

The device is provided with a mowing unit 7 for mowing the crop (FIGS. 2 and 3). Such a mowing unit 7 may be constituted by the currently often used disc-mowers or (double)-knife mowers. Although a drum-mower may be applied as well, the latter is not preferred because of its heavier weight relative to other mowing units. However, a cage-mower known per se is extremely suitable. Said cage-mower does not only enable the conveyance of the mown crop in a simple manner to a receptacle or a drag bag, but is preferable to the other known mowing units because of its safety.

The device 1 further comprises a rake unit 8 for raking mown crop. Such a rake unit is also known per se and may be constituted for example by swath boards and/or rotating rakes.

There is disposed a tedder unit 9 for tedding mown crop. Although also here it is possible to use other conventional tedder units, it is advantageous to use a drum-tedder with a comb. The drum-tedder picks up the crop and guides it through the comb, so that a frictional crushing effect is created. By switching off or pivoting away the comb, there is created a normal drum-tedder that can be used for tedding the crop. Of course, besides a comb, other crushing devices for crushing the crop may be used as well.

The tedder unit 9 may be provided, if desired, with a picking-up device (not shown) for picking up the crop.

Depending on the wishes of the user, it is possible for the device 1 to perform each processing operation separately or several processing operations simultaneously. For this purpose the device 1 is provided with a switching device 10, for example a computer, for switching on or switching off at least one of the units from the group consisting of the mowing unit, the rake unit and the tedder unit. Here it is advantageous if the switching device is additionally or alternatively suitable for switching on or switching off at least one of the devices from the group consisting of crushing equipment and picking-up equipment. For this purpose the switching device 10 is connected in a proper manner to the relevant units or devices, and is preferably capable of being programmed beforehand and/or remotely.

In order to ensure the safety of human beings and animals present in the vicinity of the autonomous device 1, said device 1 is provided with a number of protecting and safety means. The device 1 is provided with a cap 11 covering the crop-processing components, so that in particular the rotating parts are protected. There are further provided detectors, for example constituted by the camera 4, for detecting living beings present in the vicinity of the device 1. Said sensors are known per se, and as examples thereof are mentioned picture recognition, systems, colour meters, infrared meters, ultrasonic detectors, lasers, mechanical feelers, and conductivity meters.

For the sake of security, in particular the rear side is monitored by a plurality of sensors and protected by a plurality of mechanical protecting means, such as protective caps, flaps and the like.

Consequently, according to the invention the device 1 can be designed so as to have small dimensions. In particular a length of 400 cm, a width of 200 cm, and a maximum weight of 3000 kg are possible, which makes the device easily transportable. Further a motor with a small capacity of for example 40 kW can be used, so that only a small quantity of fuel needs to be on board for a working duration of for example 12 or 24 hours.

Many modifications in addition to those described above may be made to the structures and techniques described herein without departing from the spirit and scope of the invention. In particular, the devices and methods disclosed herein may also be used in conjunction with further features of the above-referenced co-pending applications. Accordingly, although specific embodiments have been described, these are examples only and are not limiting upon the scope of the invention.

1. An autonomously movable device for crop processing, comprising:
a mowing unit for mowing the crop;
a rake unit for raking the mown crop; and
a tedder unit for tedding the mown crop.

2. The autonomously movable device as claimed in claim 1, wherein the tedder unit comprises a crushing device for crushing the mown crop.

3. The autonomously movable device as claimed in claim 1, wherein the tedder unit comprises a picking-up device for picking up the mown crop.

4. The autonomously movable device as claimed in claim 1, wherein the autonomously movable device further comprises a switching device for switching on or switching off at least one of the units from the group consisting of the mowing unit, the rake unit and the tedder unit.

5. The autonomously movable device as claimed in claim 2, wherein the autonomously movable device further comprises a switching device for switching on or switching off at least one of the units from the group consisting of the mowing unit, the rake unit and the tedder unit.

6. The autonomously movable device as claimed in claim 3, wherein the autonomously movable device further comprises a switching device for switching on or switching off at least one of the units from the group consisting of the mowing unit, the rake unit and the tedder unit.

7. The autonomously movable device as claimed in claim 1, wherein the tedder unit comprises a crushing device for crushing the mown crop and a picking-up device for picking up the mown crop.

8. The autonomously movable device as claimed in claim 7, wherein the autonomously movable device further comprises a switching device for switching on or switching off at least one of the devices from the group consisting of mowing unit, rake unit, tedder unit crushing equipment and picking-up equipment.

9. The autonomously movable device as claimed in claim 1, wherein the mowing unit is a cage-mower.

10. The autonomously movable device as claimed in claim 1, wherein the tedder unit is a drum-tedder with a comb.

11. The autonomously movable device as claimed in claim 10, wherein the comb is hingeably disposed in the drum-tedder.

12. The autonomously movable device as claimed in claim 1, wherein the autonomously movable device further comprises:
a position-determining system for determining the position of the autonomously movable device;
a boundary-detecting system for detecting a boundary of mown crop; and
a control device for controlling the autonomously movable device with the aid of data from the position-determining system or the boundary-detecting system.

13. The autonomously movable device as claimed in claim 1, wherein the autonomously movable device further comprises a protecting device for protecting the autonomously movable device.
